(19) United States
(12) Patent Application Publication
(10) Pub. No.: US 2017/0288571 A1
(43) Pub. Date: Oct. 5, 2017

(54) ELECTRICAL ENERGY TRANSMISSION SYSTEM

(71) Applicants: VICTOR LANDER, Short Hills, NJ (US); JACOB GITMAN, Bay Harbor Island, FL (US); ALEXANDER BRONSHTEIN, Beer-Sheva (IL)

(72) Inventors: VICTOR LANDER, Short Hills, NJ (US); JACOB GITMAN, Bay Harbor Island, FL (US); ALEXANDER BRONSHTEIN, Beer-Sheva (IL)

(21) Appl. No.: 15/087,491

(22) Filed: Mar. 31, 2016

(51) Int. Cl. H02M 7/44; H02M 7/04; H02M 1/08

(52) U.S. Cl. CPC H02M 7/44; H02M 1/08; H02M 7/04; H02M 2001/0009

(57) ABSTRACT

An electrical energy transmission system has a three-phase electric current power source generating a three-phase electric current signal including three currents having different phases, a three-phase electric current signal converting device which converts the generated three-phase electric current signal by providing a coincidence of the phases of the currents, a single-wire electrical energy transmission line which transmits the converted electric current signal from the electric current power source to a load, and a device for adjusting electrical parameters of the electric signal at a side of the three-phase electric current power source and/or at a side of the load, when the electric current power source and/or the load have variable power parameters, to provide thereby a stable operation of the electrical energy transmission system.

### BACKGROUND OF THE INVENTION

### Field of the Invention

The present invention relates to the field of electrical systems. More particularly, the invention relates to electrical energy transmission systems which are used to transmit electrical energy generated by three-phase electric power sources over certain distances, including significantly long distances.

### Background Art

An electrical energy transmission system for transmitting a generated three-phase current conventionally includes a three-phase electrical power generator and a multi-wire electrical transmission line which transmits the generated electrical energy to a load.

There were attempts to carry out the electrical energy transmission by means of one wire. First applications of the single-wire electrical energy transmission were disclosed by Nikola Tesla in U.S. Pat. No. 1,119,736 and in British Patent No. 8,200. Another single line transmission technique is known as the Goubau line or G-line , which is a type of single wire transmission line used at UHF and microwave frequencies (see Geog Goubau, “Surface waves and their Application to Transmission Lines,” Journal of Applied Physics, Volume 21, Nov., 1950). However, a G-line is a type of waveguide, rather than a wire for an electric circuit. There was also an experiment based on the Russian patent application by Stanislav and Konstantin Avramenko [6-8}. All these concepts were based on signal processing, including frequency converting or signal rectification. They however negatively influence the process of transmission of electrical energy and lead to loss of power.

Also an electrical energy distribution method is known with the use of one conductor, it utilizes return of the electrical current through earth, according to the authors of the proposed method. This method is known as the Single Wire Earth Return (SWER). However, the simplification of the electrical energy transfer in this system is achieved at the cost of power loss due to unbalanced nature of SWER system.

Three phase electrical energy transmission systems, in which conventionally electrical energy is transmitted by four wires has significant advantages. However, the presence of three or four wires is not [symbol] the only drawback of the system. Another drawback is a line voltage between two wires in this system at the root of the three phase voltage. This may have negative consequences, such a corona effect and additional losses in the lines. Additional disadvantage of the three phase system is the need to arrange the wires at a distance of several meters from each other. This in turn makes difficult to use underground lines. It also requires wide right of way for overhead lines transmission method

A further improvement to provide an electrical energy transmission system, which transmits electrical energy generated by a three-phase electrical power source is disclosed in U.S. patent application Ser. No. 14/555,951. An electrical energy transmission system disclosed in this patent application comprises a three-phase electric current power source or generator generating a three-phase electric current signal including three currents having different phases, a three-phase electric current signal converting device connected with said three-phase electric current source and converting the three-phase electric current signal generated by the latter so that the currents have the same phases, and a single-wire electrical energy transmission line connected with said converting device and transmitting further at least a part of the converted three-phase electric current signal. The electrical energy transmission system designed this way allows a transmission of at least a part of the three-phase electric current signal through the single-wire transmission line, which results in significant economy of wires, especially in the systems which carry out transmission of electrical energy generated by three-phase electrical power sources over significant distances. This system is called Single Line Electric System or SLE.

It has been however determined that in the electrical current transmission system constructed as specified hereinabove electrical parameters or values of the current source and/or the consumer load can be variable. Their variations can disrupt proper adjustment of phases of the currents and as a result can negatively affect the operation of SLE electrical energy transmission system. Therefore it is believed that this electrical energy transmission system should be further improved to provide its efficient operation.

### SUMMARY OF THE INVENTION

Accordingly it is an object of the present invention to provide an electrical energy transmission system with a conversion of at least a part of a three-phase electric signal generated by a three-phase power source for further transmission of the electrical energy via a single line, in which the most efficient operation of the system is provided.

In keeping with these objects and with others which will become apparent hereinafter, one feature of the present invention resides, briefly stated, in an electrical energy transmission system, comprising a three-phase electric power source generating a three-phase signal including three currents having different phases, a three-phase electric current converting device which converts the generated three-phase electric signal to provide a coincidence of the phases of the currents, a single-wire electrical energy transmission line which transmits the converted electric signal from the converter to a load, and means for adjusting electrical parameters of the signal at a side of the three-phase power source and/or at a side of the load, when the power source and/or load have variable parameters, providing thereby a stable and efficient operation of the electrical energy transmission system.

In accordance with another feature of the present invention, the adjusting means include variable components selected from the group consisting of a switchable inductors, a switchable capacitors, a transformer with a fixed transformation coefficient of predetermined value, and combinations thereof.

In accordance with a further feature of the present invention, the components of the adjusting means are arranged at the side of the power source, or at the side of the load, or at both sides and operate in interaction correspondingly with other electrical components at the power source side, or at the load side, or at both sides.

In accordance with a further feature of the present invention, the adjusting means include a unit connected with the power source or to the load and having a constant impedance regardless of variations of impedance of the power source or the load.

In accordance with a further feature of the present invention, the unit having a constant impedance is configured as an energy storage device capable of producing power at a steady rate regardless of variations of impedance of the power source or the load.

In accordance with a further feature of the present invention the unit having constant impedance includes a DC to AC converter, and electric voltage and current regulators.

In accordance with a further feature of the present invention, the adjusting means include a unit for stabilizing a load which has a variable load power and configured as an impedance stabilizer.

In accordance with a further feature of the present invention, the impedance stabilizer includes single phase or three-phase an AC to DC convertor, a battery storage, and a three-phase DC to AC convertor, with electric voltage and current controllers and stabilizers.

The novel feature of the present invention are set forth in particular in the appended claims.

The invention itself, both as to its construction and its manner of operation, will be best understood from the following description of preferred embodiments, which is accompanied by the following drawings.

### BRIEF DESCRIPTION OF THE DRAWINGS

FIG. 1A of the drawings is a view schematically showing a system for transmission of electrical energy generated by a three-phase electric current power source according to a first embodiment of the present invention with a common ground as a voltage zeroing point.

FIG. 1B of the drawings is a view schematically showing a system for transmission of electrical energy generated by a three-phase electric current power source according to a first embodiment of the present invention without grounding and with a low voltage return wire.

FIG. 2A of the drawings is a view schematically showing a system for transmission of electrical energy generated by a three-phase electric current source according to a second embodiment of the present invention with a common ground as a voltage zeroing point.

FIG. 2B of the drawings is a view schematically showing a system for transmission of electrical energy generated by a three-phase electric current source according to a second embodiment of the present invention without grounding and with a low voltage return wire.

FIG. 3A of the drawing is a view schematically showing a system of transmission of electrical energy generated by a three-phase electric current power source according to a third embodiment of the present invention with a common ground as a voltage zeroing point.

FIG. 3B of the drawing is a view schematically showing a system of transmission of electrical energy generated by a three-phase electric current power source according to a third embodiment of the present invention without grounding and with a low voltage return wire.

FIG. 4A of the drawing is a view schematically showing a system of transmission of electrical energy generated by a three-phase source with fixed impedance and a load with variable impedance according to a fourth embodiment of the present invention with a common ground as a voltage zeroing point.

FIG. 4B of the drawing is a view schematically showing a system of transmission of electrical energy generated by a three-phase source with fixed impedance and a load with variable impedance according to a fourth embodiment of the present invention without grounding and with a low voltage return wire.

### DETAILED DESCRIPTION OF THE INVENTION

An electrical energy transmission system according to the present invention includes a three-phase electric power source or electrical generator which is identified as a whole with reference numeral 1 and is designed to transmit electrical energy to a consumer or load 2 through a single wire transmission line (SLE) 3. The three-phase electric current power source generates three-phase electric current signal including three currents transmitted correspondingly through three wires or lines A, B, C.

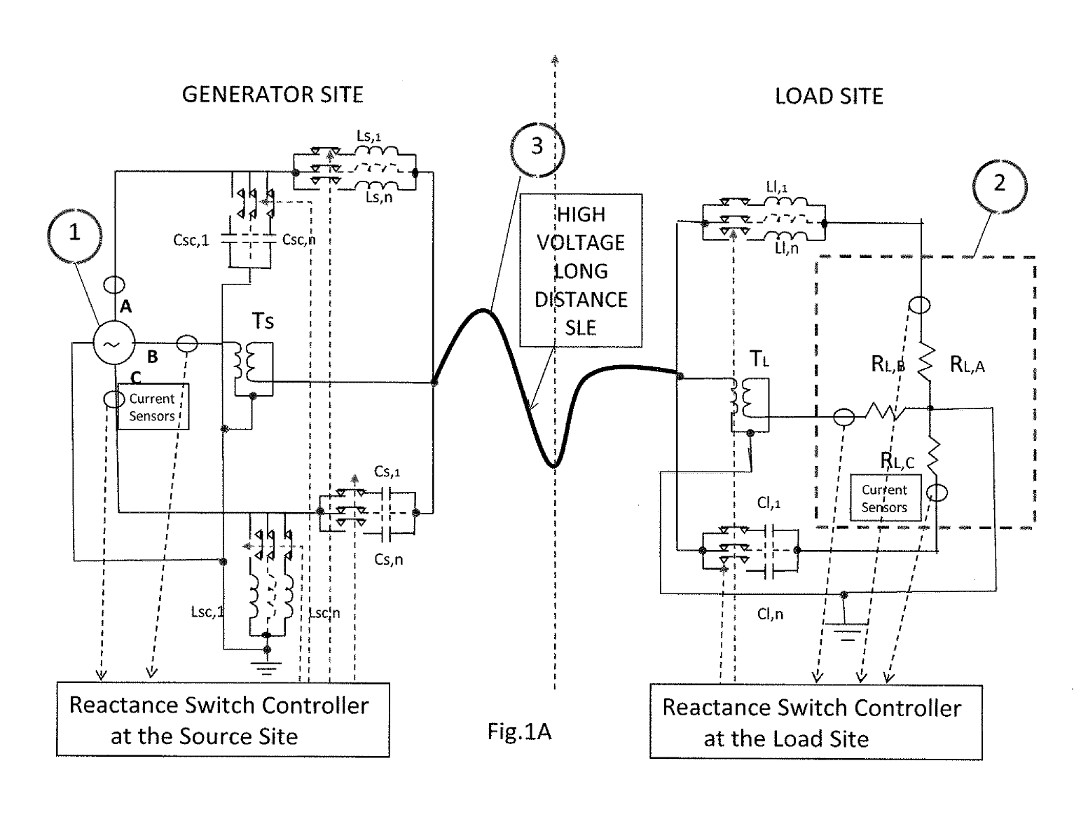

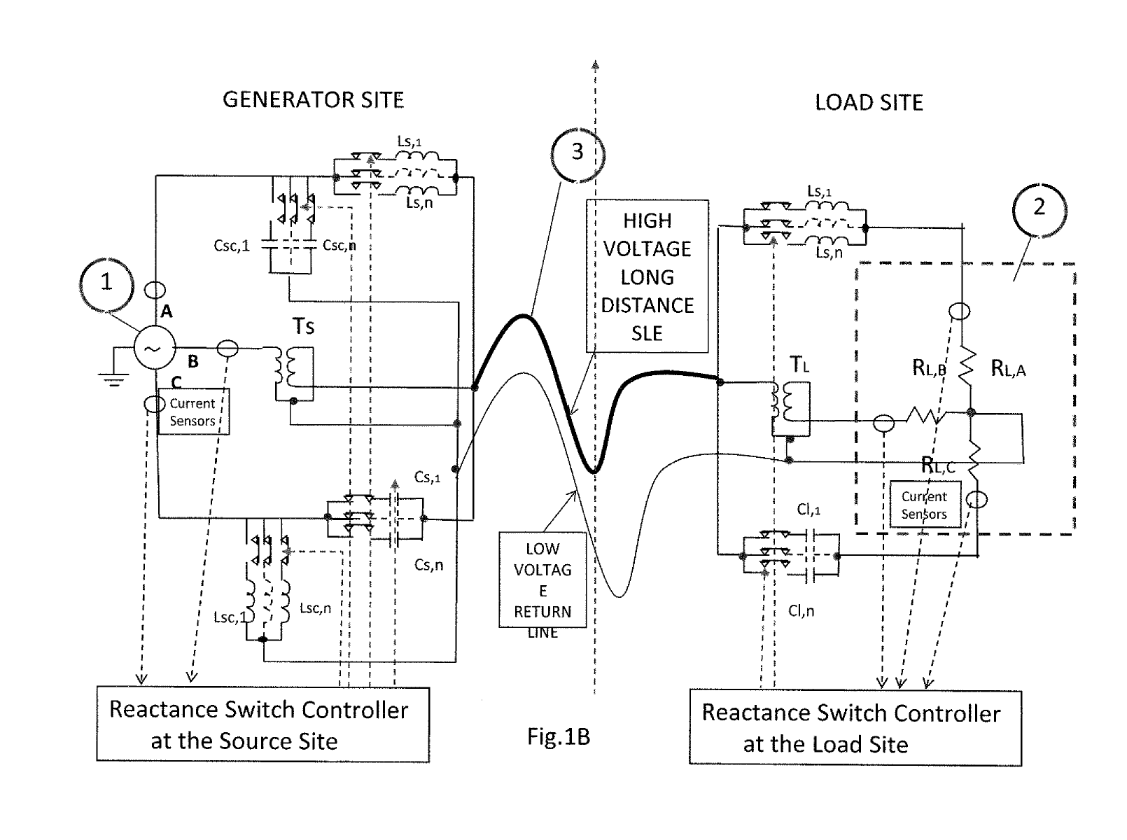

in order to transmit three currents of three-phase electric current signal, where currents have different phases that are offset from one another by 120 degrees, a converting device can be provided at the power source or generator and also at the load or consumer in the electrical energy transmission system of the invention. The converting device includes capacitors, transformer and inductors which operate as phase shifters to shift phases of the three currents so that they all have the same phase. As shown in FIGS. 1A and 1B, at the power source or generator site inductors Ls,₁-Ls,n are installed in line A, capacitors Cs,₁-Cs,n are installed in line C, and a transformer Ts with reversed secondary winding is installed in line B. Additionally, there are also reactive load compensating components Csc,₁-Csc,n and Lsc,₁-Lsc,n used for compensating excessive reactance in input impedance of each line, to improve the operation of the generator. The switching controller receives information on power at each phase line via current sensors and controller turns on/off the switch at the reactance corresponding to the measured power. The number of reactances and granularity of the system is determined by the specific requirements that include voltage variation tolerance and power range. FIG.1A shows one embodiment of this invention with grounding used as voltage zeroing method at the generator and load sites. FIG.1B shows the same embodiment with return low voltage wire that eliminates grounding as a voltage zeroing at the load and generator sites.

Similar converting device is provided at the side of the load or consumer, in order to convert the electrical signal transmitted through the single line 3 into a three-phase electric signal if the load requires it. The load alternatively can require a one phase electric signal, in which case only one transformer will be used. If however it is necessary to obtain a three-phase electric current signal, then the converting device at the side of the load 3 will be provided with the capacitors C_{L,1}-C_{L},n, inductors L_{l,1}-L_{l.n}, and a transformer T_{L}, which convert the electric current signal received through the single line 3 into a three-phase electric current.

It should be emphasized that the values of these reactances and transformation coefficients of the transformers are not arbitrary, and they depend on the values of the power source (generator) and/or of the load (consumer). Therefore in order to provide proper conversion of the electric currents of the three-phase electric signal for SLE transmission from the power source (generator) through the single line, and then proper conversion of the received SLE signal into a three-phase electric current in the cases of a variable power source and/or variable load, a continuous adjustment of electrical components at the power source side and/or at the load side is needed. Such variable components are shown in FIG. 1 as switchable reactors, in particular a set of switchable inductors, a set of switchable capacitors and transformers. Each reactive component has a different value, and a size of a step is determined by expected variations in impedance of the power source and/or in impedance of the load and allowed tolerances for voltage variations. The switching of the switchable reactors is performed by high power switching systems, such as typically used in high power generation and grid industry to maintain voltage and power stability of the grid. Sensors located in each line and identified by small circles in FIGS. 1 and 1A provide signals to a control module of a switching bank, and the switching bank selects a proper component value for a new power level.

It is to be understood that sometimes the implementation of constant adjustment of components in the cases of variable power sources and/or variable loads can be a serious obstacle for cost-efficient implementation of the electrical energy transmission system with the use of a single-wire transmission line, in particular for high power applications, where such components are very expensive and may not be available at all.

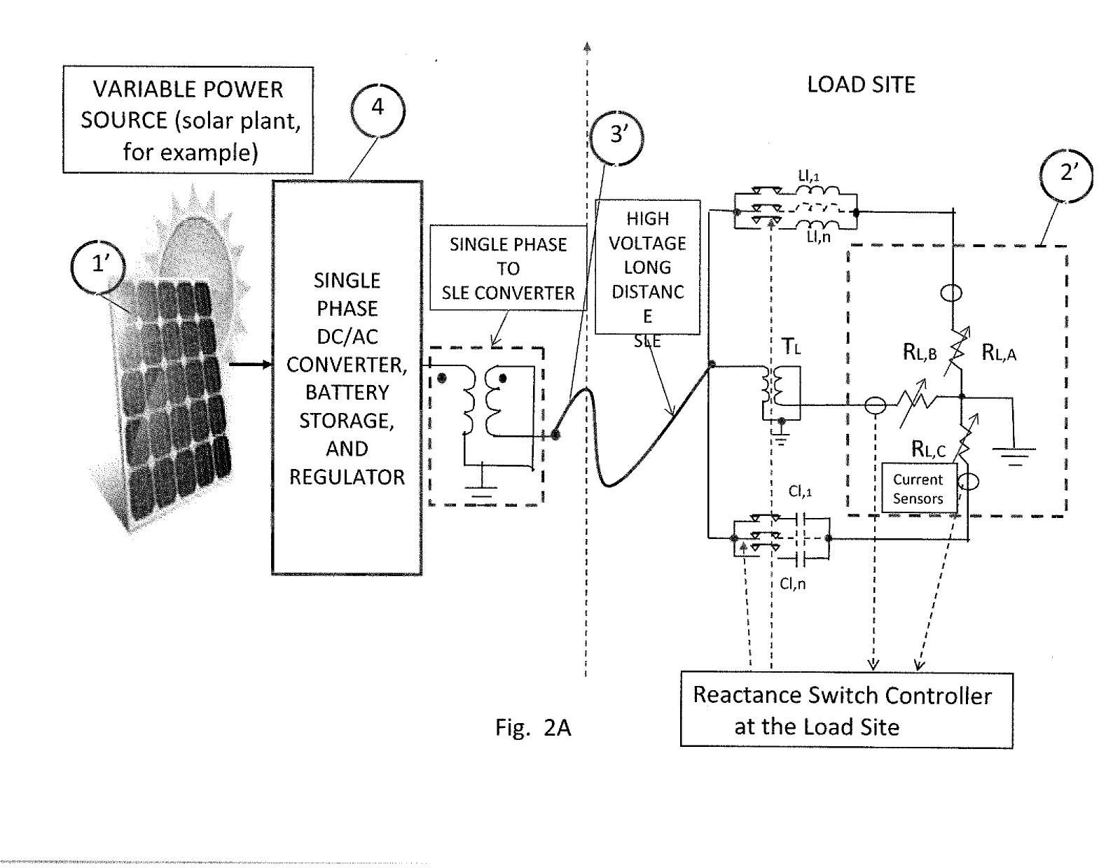

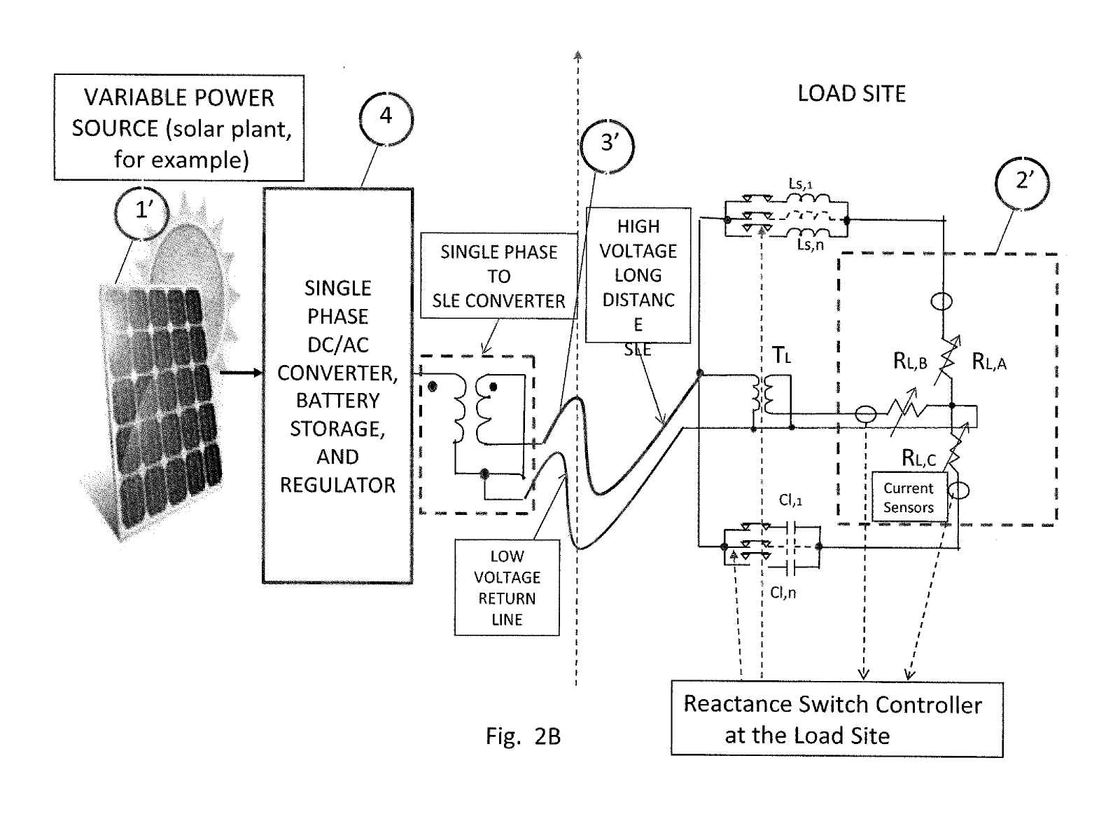

FIGS. 2A and 2B disclose another embodiment of the electrical energy transmission system according to the present invention. The system includes a power source or a generator 1′ which produces a variable power. Such a power source can be for example a solar power plant which produces a variable power during a day time and does not generate a significant power during a night time. It also can be, for example, a wind turbine farm. When such generators with stabilized output voltage change the power, the current also changes and in turn variable source impedance is produced. For a proper operation of the electric energy transmission system, these variations have to be compensated by changing values of reactances Cs and Ls.

According to the present invention in the embodiment of FIGS. 2A and 2B, a constant impedance unit or buffer 4 is used which eliminates all impedance variations by its buffer stage. The constant power electric current signal then exits, providing the constant impedance, and is converted as in the inventive system to have electric currents of the same phase to be transmitted through a single line 3′ to the load 2′.

Any energy storage device capable of producing electric power at a steady rate can be used as the constant impedance unit 4, such as the battery storage devices used for large utilities, high-speed flywheels, super capacitors, etc.

The constant impedance unit 4 according to an exemplary embodiment shown in FIGS. 2A and 28 is a battery storage system which includes a DC to AC convertor, voltage and current regulators, and a battery bank of a required size with a capacity determined by required power variations. For the case when solid state control and switching devices are used, DC current from solar panels can be converted to a single phase AC, which in turn can be converted to SLE by using a phase inverter (transformer with inverted secondary winding) to be transmitted through the single line 3′.

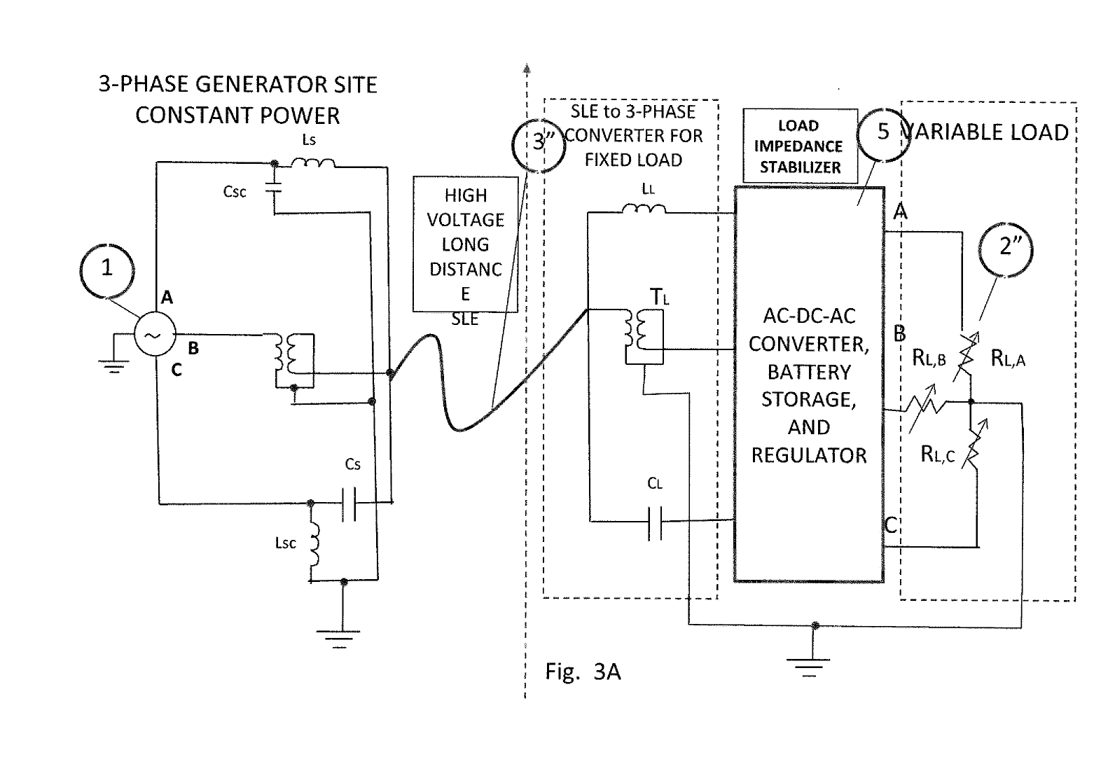

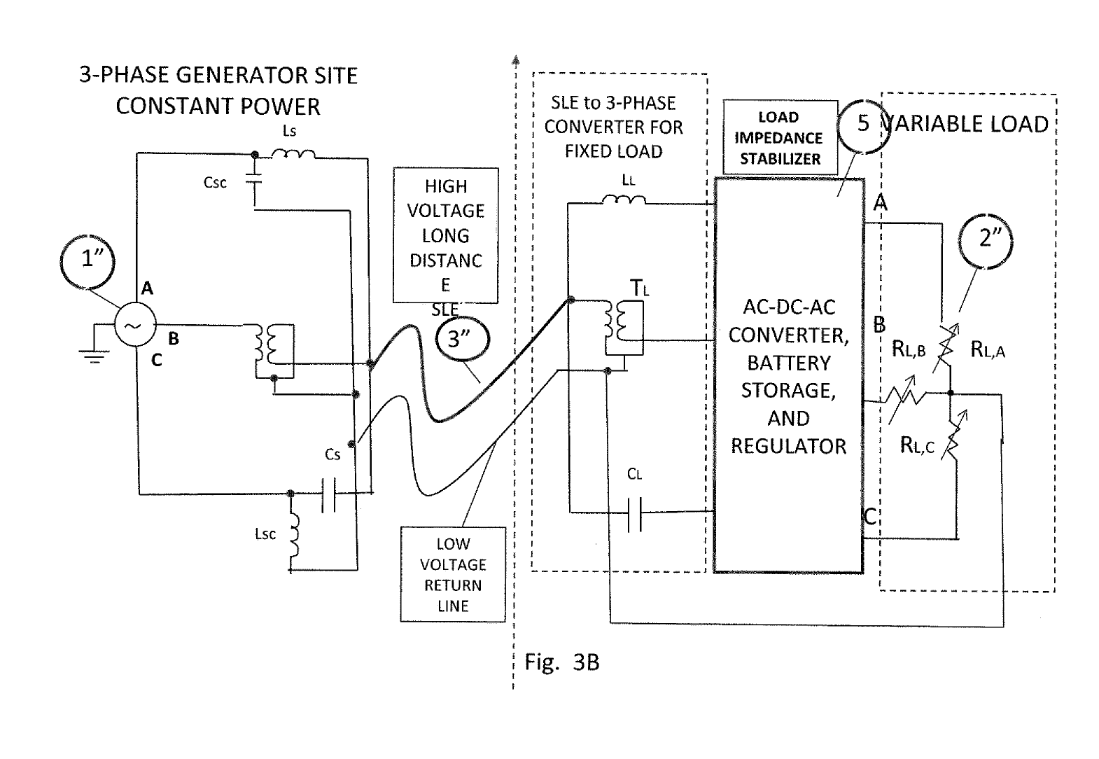

FIGS. 3A and 3B show a further embodiment of the electrical energy transmission system according to the present invention for the application when the load 2″ has a variable power. An impedance stabilizer, which can be configured as a solid state impedance stabilizer 5 may include an AC to DC converter, a battery storage, and a three-phase DC to AC converter, with voltage and current controllers and stabilizers. In this embodiment the power source 1″ has a stable output power and voltage, for example, a grid. The three-phase electric current signal generated by the stable power source is converted by shifting the phases of the three currents so that they obtain the same phase and then transmitted through the single line 3″.

At the side of the load the transmitted SLE electric current signal is converted into a three phase current. It serves as an input for the solid state impedance stabilizer 5 which is associated with the load 2″ and has a three phase current input and a three-phase current output. Impedance variations of the load are stabilized by the buffer stage of the impedance stabilizer. The need for variable components is eliminated.

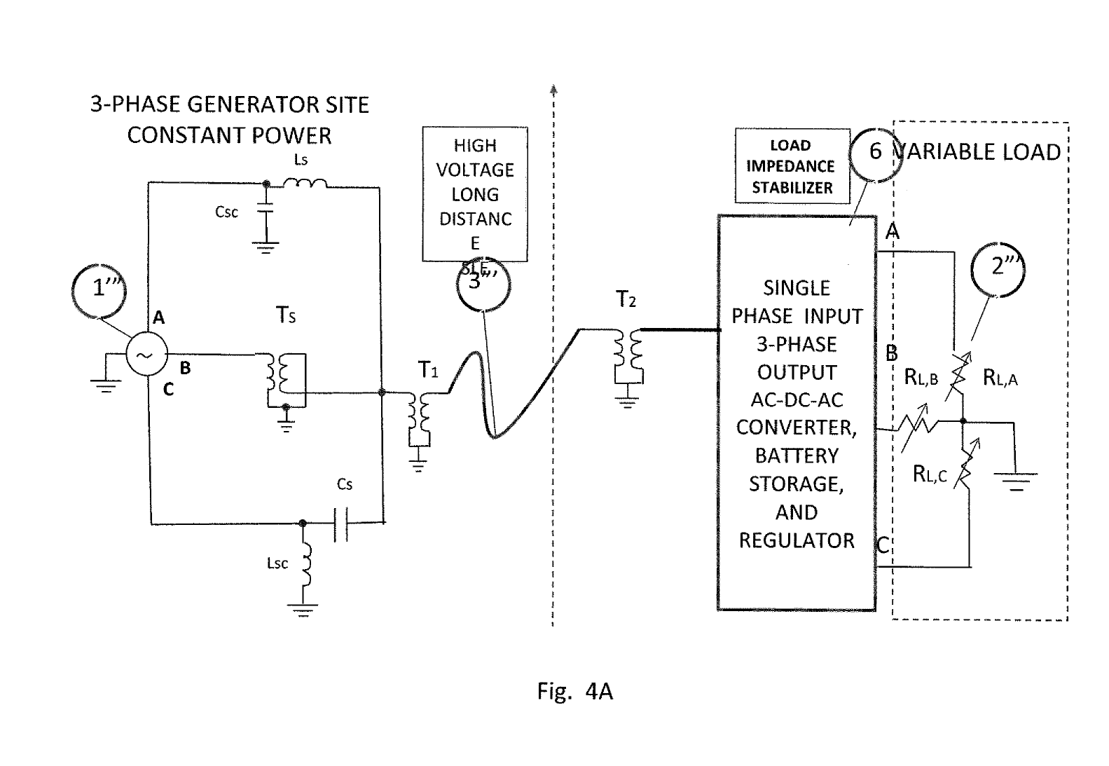

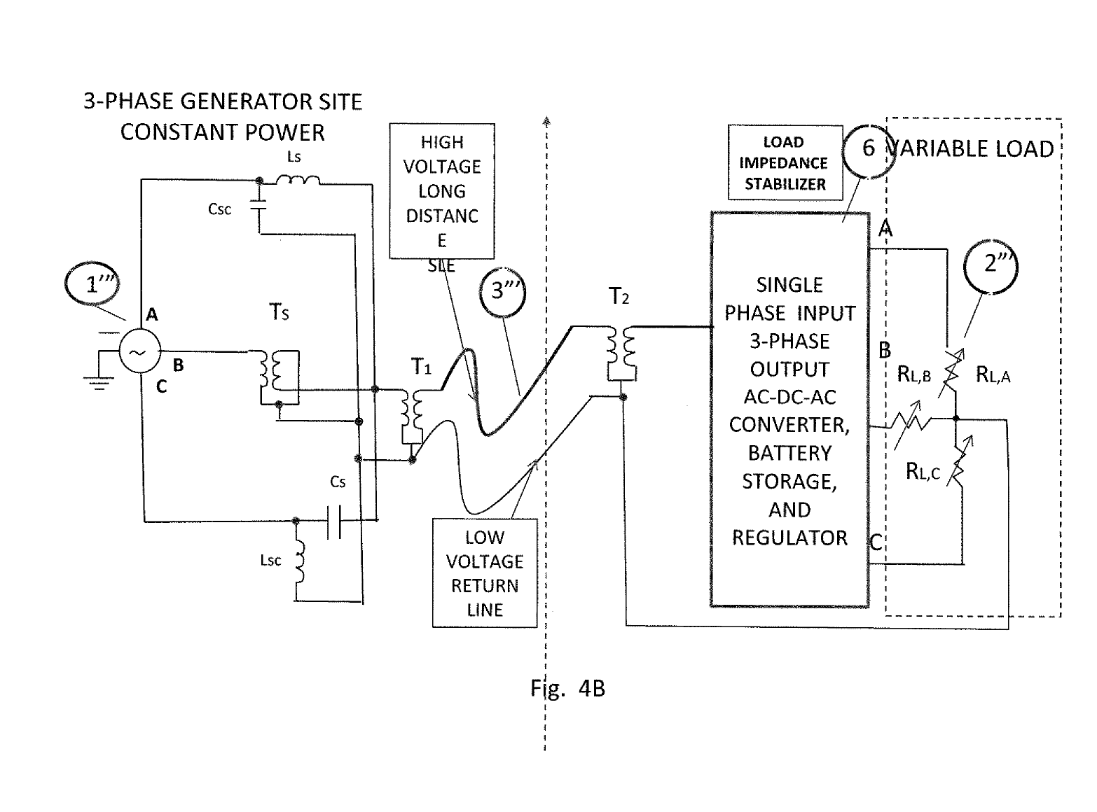

FIGS. 4A and 4B show a further embodiment of the electrical energy transmission system according to the present invention for the application when the load 2′″ has a variable power. An impedance stabilizer, which can be configured as a solid state impedance stabilizer 6 may include an AC to DC converter, a battery storage, and a three-phase DC to AC converter, with voltage and current controllers and stabilizers. In this embodiment the power source 1′″ has a stable output power and voltage, for example, a grid. The three-phase electric current signal generated by the stable power source is converted by shifting the phases of the three currents so that they obtain the same phase and then transmitted through the single line 3′″. In the transmission section a step-up transformer T1 at the source and a step-down transformer T2 at the load can be optionally installed to minimize the current which flows through the single line 2′″.

At the side of the load the transmitted SLE electric current signal is converted into a single phase current. It serves as an input for the solid state impedance stabilizer 6 which is associated with the load 2′″ and has a single phase input and a three-phase current output. Impedance variations of the load are stabilized by the buffer stage of the impedance stabilizer. The need for variable components is eliminated.

It is to be understood that in the event when both the power source and the load are such that they operate with impedance variations, then one impedance stabilizer can be provided to be associated with the power source and another impedance stabilizer can be provided to be associated with the load. Similarly, if economy analysis of the project makes it preferable, one set of switching reactances can be provided for the source and another set of witching reactances can be provided for the load with corresponding switching controllers.

The present invention is not limited to the details shown, since various modifications and structural changes are possible without departing in any way from the spirit of the invention.

What is desired to be protected by Letters Patent is set forth in particular in the appended claims.

1. An electrical energy transmission system, comprising a three-phase electric current power source generating a three-phase electric current signal including three currents having different phases, a three-phase electric current signal converting device which converts the generated three-phase electric current signal by connected each phase to appropriate reactive element and transformer and providing a coincidence of the phases of all three currents, a single-wire electrical energy transmission line which transmits the converted electric current signal from the power source to a load, and means for adjusting electrical parameters of the electric current signal at a side of the three-phase electric current power source and/or at a side of the load, when the electric current power source and/or load have variable power parameters, to provide thereby a stable and efficient operation of the electrical energy transmission system. The transmission system may consist from a single wire with voltage zeroing at the source and at the load using ground, or it may consist from two wires, one high voltage and one low voltage return current wire, which is connected to the common neutral points at the source and at the load sites.

2. The electrical energy transmission system of claim 1, wherein the adjusting means include variable components selected from the group consisting of a switchable inductor, a switchable capacitor, a transformer with a variable transformation coefficient (if needed), and combinations thereof.

3. The electrical energy transmission system of claim 2, wherein the variable components of the adjusting means are arranged at the side of the power source, or at the side of the load, or at both sides and operate in interaction correspondingly with other electrical components at the power source side, or at the load side, or at both sides.

4. The electrical energy transmission system of claim 3, wherein the adjusting means include a unit connected with the power source and having a constant impedance regardless of variations of impedance of the power source.

5. The electrical energy transmission system of claim 4, wherein the unit having constant impedance is configured as an energy storage device capable of producing power at a steady rate regardless of variations of impedance of the power source.

6. The electrical energy transmission system of claim 5, wherein the unit having constant impedance includes a DC to AC converter, and electric voltage and current regulators.

7. The electrical energy transmission system of claim 3, wherein the adjusting means include a unit for stabilizing a load which has a variable load power and configured as an impedance stabilizer.

8. The electrical energy transmission system of claim 7, wherein the impedance stabilizer includes an AC to DC convertor, a battery storage, and a three-phase DC to AC convertor, with electric voltage and current controllers and stabilizers.
